(19) United States
(12) Patent Application Publication
(10) Pub. No.: US 2024/0118688 A1
(43) Pub. Date: Apr. 11, 2024

(54) INFORMATION PROCESSING METHOD

(71) Applicant: TOYOTA JIDOSHA KABUSHIKI KAISHA, Aichi-ken (JP)

(72) Inventors: Shin SAKURADA, Toyota-shi (JP); Kazuyuki INOUE, Nagoya-shi (JP); Jean-Sebastien BOIRE, Yokohama-shi (JP); Kiyonori YOSHIDA, Toyota-shi (JP); Ai MIYATA, Sakai-shi (JP); Yuki TATSUMOTO, Seto-shi (JP)

(21) Appl. No.: 18/481,236

(22) Filed: Oct. 5, 2023

(30) Foreign Application Priority Data
Oct. 7, 2022 (JP) 2022-162780

(51) Int. Cl. G05D 1/00; B60L 53/66; G01C 21/34

(52) U.S. Cl. CPC G05D 1/0011; B60L 53/66; G01C 21/3469; B60L 2240/72

(57) ABSTRACT

An information processing method by an information processing apparatus capable of communicating with one or more vehicles delivering packages, the information processing method includes acquiring vehicle-related information including the position of each vehicle, the energy charge amount of each vehicle, the travel condition of each vehicle, a temperature, the weight of packages on each vehicle, delivery destination information on the packages on each vehicle, energy charging station information near a delivery route of each vehicle, and/or road congestion information, generating, from the vehicle-related information, plans for delivery routes and/or energy charge timings with the highest energy efficiency, and commanding the one or more vehicles to execute the plans.

### CROSS-REFERENCE TO RELATED APPLICATION

This application claims priority to Japanese Patent Application No. 2022-162780, filed on Oct. 7, 2022, the entire contents of which are incorporated herein by reference.

### TECHNICAL FIELD

The present disclosure relates to an information processing method.

### BACKGROUND

Commercial electric vehicles are known (e.g., Patent Literature (PTL) 1).

### CITATION LIST

### Patent Literature

PTL 1: JP 2022-073238 A

### SUMMARY

Once vehicles leave for delivery, each vehicle travels around an area assigned to each individual vehicle. Accordingly, from an overall perspective, it is not possible to grasp the wastefulness of travel routes, the efficient timings of energy charging, and the like.

It would be helpful to assist the efficiency of energy charging.

An information processing method according to an embodiment of the present disclosure is an information processing method by an information processing apparatus capable of communicating with one or more vehicles delivering packages, the information processing method including:
acquiring vehicle-related information including a position of each vehicle, an energy charge amount of each vehicle, a travel condition of each vehicle, a temperature, a weight of a package on each vehicle, delivery destination information on the package on each vehicle, energy charging station information near a delivery route of each vehicle, and/or road congestion information;
generating, from the vehicle-related information, plans for delivery routes and/or energy charge timings with highest energy efficiency; and
commanding the one or more vehicles to execute the plans.

According to an embodiment of the present disclosure, the efficiency of energy charging can be assisted.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a block diagram illustrating a configuration of a vehicle;

FIG. 4 is a diagram illustrating a data structure of a vehicle-related information database (DB); and

FIG. 5 is a flowchart illustrating operations of the information processing apparatus.

### DETAILED DESCRIPTION

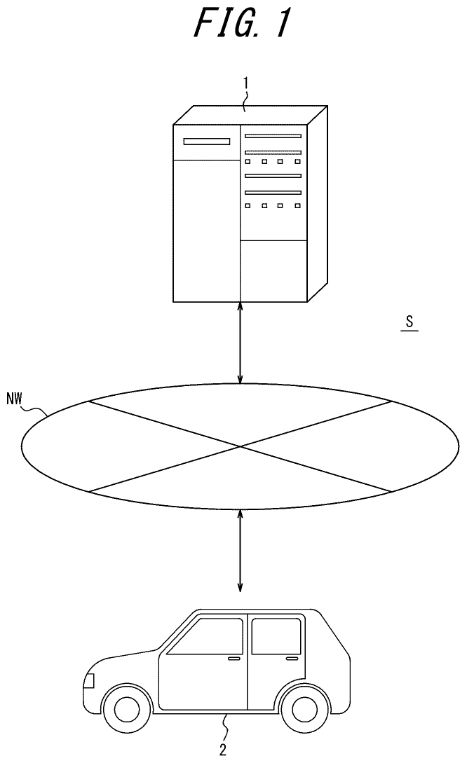

FIG. 1 is a schematic diagram of an information processing system S according to the present embodiment. The information processing system S includes an information processing apparatus 1 and a vehicle 2. The information processing apparatus 1 can communicate with the vehicle 2 via a network NW. The network NW includes, for example, a mobile communication network, the Internet, or a fixed communication network.

FIG. 1 illustrates one of the information processing apparatus 1 and one of the vehicle 2, for convenience of explanation. However, the number of information processing apparatuses 1 and the number of vehicles 2 are not limited to this. For example, processing to be executed by the information processing apparatus 1 may be executed by a plurality of distributed information processing apparatuses 1. The information processing apparatus 1 may be capable of communicating with multiple vehicles 2.

The information processing apparatus 1 may be a server that assists a provider in providing a service. The information processing apparatus 1 may be, for example, installed in a facility dedicated to the provider or in a shared facility including a data center. As an alternative example, the information processing apparatus 1 may be mounted in the vehicle 2. The information processing apparatus 1 may be referred to as a center server.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

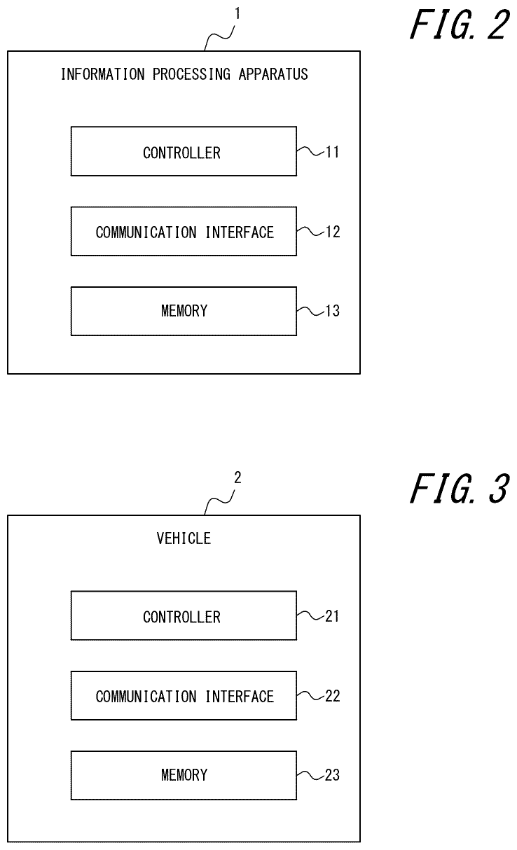

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU).

The communication interface 12 includes, for connecting to a network, one or more communication modules that conform to wired or wireless local area network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations or control of the information processing apparatus 1. The memory 13 may store a system program, an application program, embedded software, and the like. The memory 13 may be provided outside the information processing apparatus 1 and accessed by the information processing apparatus 1. The memory 13 includes a vehicle-related information DB.

With reference to FIG. 3, an internal configuration of the vehicle 2 will be described in detail.

The vehicle 2 includes a controller 21, a communication interface 22, and a memory 23. The components of the vehicle 2 are communicably connected to one another, for example, via dedicated lines.

The description of the hardware configurations of the controller 21, communication interface 22, and memory 23 may be the same as the description of the hardware configurations of the controller 11, communication interface 12, and memory 13, respectively. The explanation here is omitted.

Hereinafter, processing executed by the information processing system S according to the present embodiment will be described in detail. As an example here, one or more vehicles 2 deliver packages.

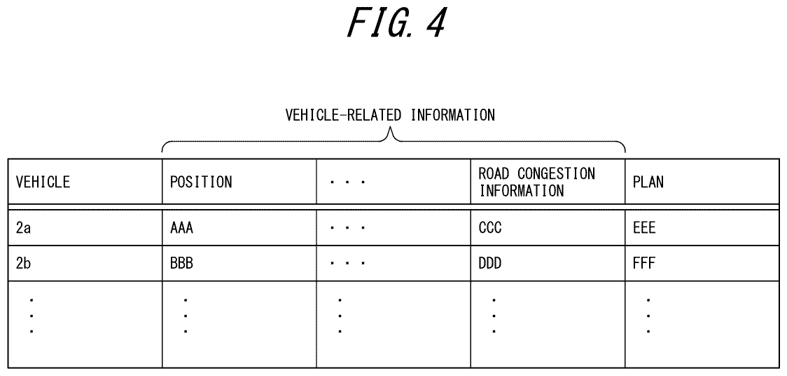

The controller 11 of the information processing apparatus 1 acquires vehicle-related information. As illustrated in FIG. 4, the controller 11 stores the vehicle-related information in the memory 13. The vehicle-related information is acquired from other information processing apparatuses or from each vehicle. The vehicle-related information includes at least one of the following:
Position of each vehicle
Energy charge amount of each vehicle
Travel condition of each vehicle
Temperature
Weight of packages on each vehicle
Delivery destination information on packages on each vehicle
Energy charging station information near delivery route of each vehicle
Road congestion information

The controller 11 generates, from the vehicle-related information, plans for delivery routes and/or energy charge timings with the highest energy efficiency. The plans may be generated based on past history or determined from a table that stores correspondences between the vehicle-related information and plans. Charging of energy includes storing (charging) electricity and/or refueling hydrogen.

The controller 11 commands the vehicles 2 to execute the plans. Specifically, the controller 11 transmits information indicating the plans to the vehicles 2. The vehicles 2 perform delivery and charging of energy according to the plans.

When the vehicles 2 are FCEVs, the controller 11 plans to perform charging of energy at hydrogen refueling stations. The controller 11 reserves, based on the plans, the hydrogen refueling stations at which charging of energy is performed and qualified persons to handle hydrogen refueling at the hydrogen refueling stations. The information processing apparatus 1 accesses a server, which accepts reservations, and makes reservations.

When the vehicles 2 are BEVs, the controller 11 plans to perform charging of energy at electricity charging stations. The controller 11 reserves, based on the plans, fast charging stations.

The controller 11 generates the plans for the delivery routes and/or energy charge timings so that reservations for each energy charging station are distributed. For example, the controller 11 identifies, based on past history, time periods in which reservations for energy charging stations tend to be concentrated. In generating the plans, the controller 11 plans the delivery routes or energy charge timings that can avoid the identified time periods.

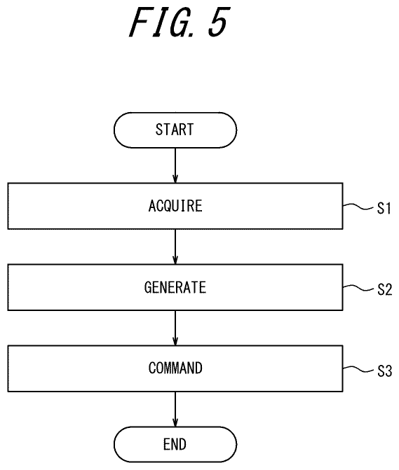

An information processing method by the information processing apparatus 1 will be described with reference to FIG. 5.

In step S1, the controller 11 of the information processing apparatus 1 acquires vehicle-related information. In step S2, the controller 11 generates, from the vehicle-related information, plans for delivery routes and/or energy charge timings with the highest energy efficiency. In step S3, the controller 11 commands one or more vehicles 2 to execute the plans.

According to the present embodiment, as described above, the controller 11 of the information processing apparatus 1 performs operations that include acquiring vehicle-related information including the position of each vehicle, the energy charge amount of each vehicle, the travel condition of each vehicle, a temperature, the weight of packages on each vehicle, delivery destination information on the packages on each vehicle, energy charging station information near a delivery route of each vehicle, and/or road congestion information, generating, from the vehicle-related information, plans for delivery routes and/or energy charge timings with the highest energy efficiency, and commanding one or more vehicles 2 to execute the plans. With this configuration, the information processing apparatus 1 can assist the efficiency of energy charging.

Also according to the present embodiment, when the one or more vehicles 2 include an FCEV, the operations of the controller 11 include reserving, based on the plans, a hydrogen refueling station and a qualified person to handle hydrogen refueling. With this configuration, the information processing apparatus 1 can assist refueling of hydrogen.

Also according to the present embodiment, when the one or more vehicles 2 include a BEV, the operations of the controller 11 include reserving, based on the plans, a fast charging station. With this configuration, the information processing apparatus 1 can assist fast charging of the vehicle 2.

According to the present embodiment, the operations of the controller 11 also include generating the plans for the delivery routes and/or energy charge timings so that reservations for each energy charging station are distributed. With this configuration, the information processing apparatus 1 reduces congestion at the energy charging station and reduces waiting time for the vehicles 2 at the energy charging station, thereby making energy charging more efficient.

According to the present embodiment, charging of energy includes storing electricity and/or refueling hydrogen. With this configuration, the information processing apparatus 1 can accommodate a variety of types of energy charging.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read a program directly from a portable recording medium, and execute processes in accordance with the program. The computer may, each time a program is transferred from a server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to the program. For example, data that is not a direct command to a computer but has a property that regulates processing of the computer is “equivalent to a program” in this context.

1. An information processing method by an information processing apparatus capable of communicating with one or more vehicles delivering packages, the information processing method comprising:
acquiring vehicle-related information including a position of each vehicle, an energy charge amount of each vehicle, a travel condition of each vehicle, a temperature, a weight of a package on each vehicle, delivery destination information on the package on each vehicle, energy charging station information near a delivery route of each vehicle, and/or road congestion information;
generating, from the vehicle-related information, plans for delivery routes and/or energy charge timings with highest energy efficiency; and
commanding the one or more vehicles to execute the plans.

2. The information processing method according to claim 1, comprising reserving, based on the plans, a hydrogen refueling station and a qualified person to handle hydrogen refueling when the one or more vehicles include a fuel cell electric vehicle.

3. The information processing method according to claim 1, comprising reserving, based on the plans, a fast charging station when the one or more vehicles include a battery electric vehicle.

4. The information processing method according to claim 1, comprising generating the plans for the delivery routes and/or the energy charge timings so that reservations for each energy charging station are distributed.

5. The information processing method according to claim 1, wherein charging of energy includes storing electricity and/or refueling hydrogen.
